(19) United States
(12) Patent Application Publication
(10) Pub. No.: US 2011/0018221 A1
(43) Pub. Date: Jan. 27, 2011

(54) WHEELCHAIR HAVING REVERSIBLE SEAT RAIL SUPPORT STRUCTURE

(76) Inventor: Benjamin A Anooshian, Fresno, CA (US)

Correspondence Address: MACMILLAN SOBANSKI & TODD, LLC, ONE MARITIME PLAZA FIFTH FLOOR, 720 WATER STREET, TOLEDO, OH, 43604-1619, US

(21) Appl. No.: 12/509,881

(22) Filed: Jul. 27, 2009

(51) Int. Cl. B62M 1/14; A47C 7/02

(52) U.S. Cl. 280/250.1; 297/452.2

(57) ABSTRACT

A support element is configured to position a wheelchair seat rail and a frame member relative to each other. The support element has a first end configured to freely admit and release one of the seat rail and the frame member and a second end configured to releasably retain the other of the seat rail and the frame member.

### BACKGROUND OF THE INVENTION

This invention relates in general to folding wheelchairs. In particular, this invention relates to a folding wheelchair having a support structure for connecting wheelchair frame members.

Wheelchairs are a class of personal mobility vehicle that provide greater ambulatory freedom to persons having limited movement abilities. Wheelchairs may be constructed having rigid frames to provide a solid or sturdy feeling to a user. Alternatively, wheelchairs may be foldable to provide greater portability. Folding wheelchairs often have frame support elements that secure mating frame components together. An improved and more adaptable connection between a wheelchair seat rail and a side frame member would be desirable.

### SUMMARY OF THE INVENTION

This invention relates to a support element for positioning a wheelchair seat rail and a frame member relative to each other. The support element has a first end and a second end. The first end is configured to freely admit and release one of the seat rail and the frame member. The second end is configured to releasably retain the other of the seat rail and the frame member.

This invention further relates to a wheelchair that comprises a frame having a first frame member and a second frame member. The second frame member is movable relative to the first frame member. A support element has a first end configured to freely admit and release one of the first and second frame members of the wheelchair. The support element further has a second end configured to releasably retain the other one of the first and second frame members of the wheelchair.

This invention further relates to a folding wheelchair that includes a frame having spaced apart first and second side frame members and a pair of intersecting cross braces that are first and second cross braces. The first cross brace is pivotally connected to the first side frame and extends to the second side frame in an unfolded position. The second cross brace is pivotally connected to the second side frame and extends to the first side frame in the unfolded position. A first seat rail is connected to the first cross brace and positioned adjacent to the second side frame member in the unfolded position. A second seat rail is connected to the second cross brace and positioned adjacent to the first side frame member in the unfolded position. A reversible seat rail saddle connects the first seat rail to the second side frame member. The reversible seat rail saddle has a first end configured to freely admit and release one of the first and second frame members and a second end configured to releasably retain the one of the first and second frame members.

Various aspects of this invention will become apparent to those skilled in the art from the following detailed description of the preferred embodiment, when read in light of the accompanying drawings.

### BRIEF DESCRIPTION OF THE DRAWINGS

FIG. 1 is a perspective view of a folding wheelchair having a reversible seat rail support saddle.

FIG. 2 is an elevational view of the side frame, seat rail, and reversible support saddle of the wheelchair of FIG. 1.

FIG. 3 is an enlarged perspective view of the reversible seat rail support saddle of FIG. 1.

FIG. 4A is an elevational view of the reversible seat rail support saddle of FIG. 3.

FIG. 4B is an elevational view of an alternative embodiment of the seat rail support saddle of FIG. 4A.

FIG. 4C is an elevational view of an alternative embodiment of the seat rail support saddle of FIG. 4A.

FIG. 4D is an end view of the seat rail support saddle of FIG. 4C.

FIG. 5 is an exploded view of the seat rail saddle support and frame member assembly of FIG. 2.

FIG. 6 is an elevational view of the seat rail saddle showing a release characteristic in a first orientation.

FIG. 7 is an elevational view of the seat rail saddle of FIG. 6 showing a release characteristic in a second orientation.

FIG. 8 is an embodiment of a reversible seat rail saddle having an alternative retaining structure.

FIG. 9 is another embodiment of a reversible seat rail saddle having an alternative retaining structure.

### DETAILED DESCRIPTION OF THE PREFERRED EMBODIMENT

In general, mating frame components of a folding wheelchair, for example a seat rail and a side frame member, may be secured together by locking frame support elements that fix the frame members together. Alternatively, the frame support elements may be open structures without locking means, such as “U”-shaped nests, that allow, for example, the seat rail to be supported relative to the frame member in a free-floating condition.

The overall wheelchair stiffness, particularly the connection between the seat rail and frame members, for example side frame members, when articulated into an unfolded position, has a direct impact on the ride characteristic. When operating a folding wheelchair, some users may prefer a more rigid ride characteristic. Some of these users have sufficient dexterity to actuate frame support locking mechanisms. Other users may not be able to unlatch the locking mechanisms and would therefore prefer a more readily foldable wheelchair. Whether locking or free-floating, folding wheelchairs generally have one type of support to position the seat rail relative to the side frame member.

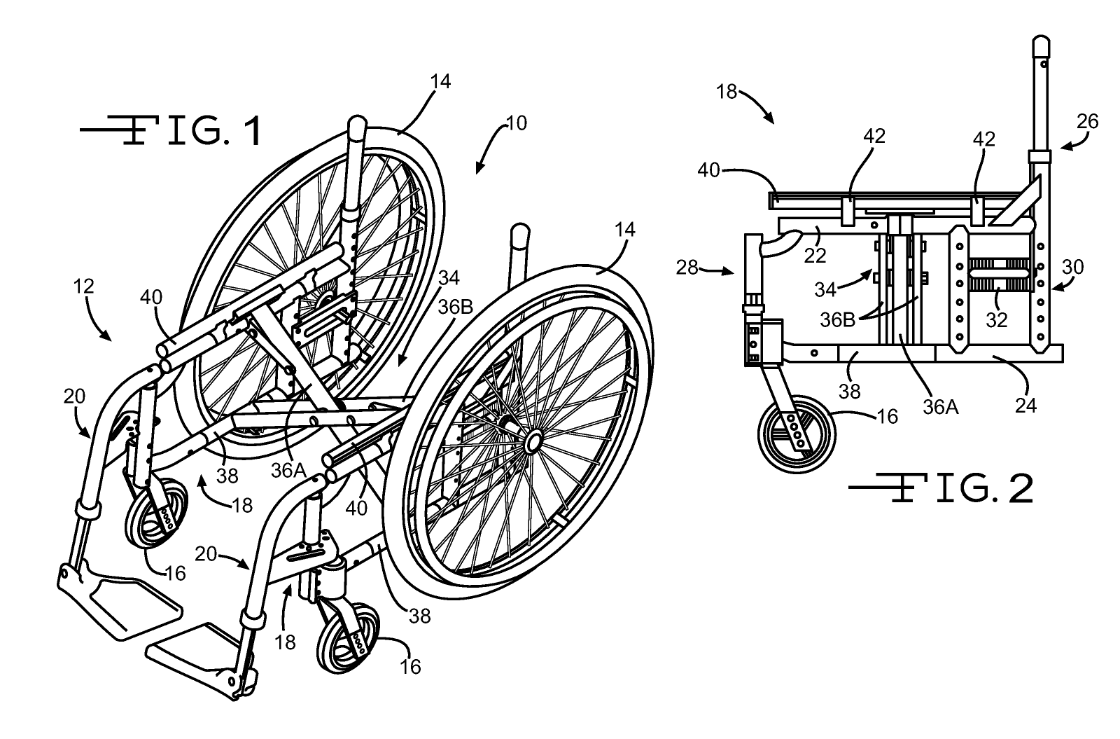

Referring now to the drawings, there is illustrated in FIG. 1 a folding wheelchair 10 that includes a frame 12, a pair of spaced apart drive wheels 14, and a pair of pivotable caster wheels 16. The drive wheels 14 are shown as manual drive wheels, however, in an alternative embodiment the drive wheels 14 may be power driven wheels. While the caster wheels 16 are shown as front-mounted caster wheels, an alternative mounting arrangement such as, for example, rear mounted caster wheels may be used. The frame 12 is a folding frame that includes a pair of side frames, shown generally at 18 in FIGS. 1 and 2, and an adjustable footrest assembly 20.

Referring now to FIG. 2, the side frame 18 is illustrated having an upper frame member 22, a lower frame member 24, a back support member 26, and a front tube member 28. The side frame 18 may also include an axle mount 30, shown as an axle plate 32 that is height adjustable and wheelbase adjustable between the upper and lower frame members 22 and 24, though such adjustability is not required. The side frame 18 may be other than illustrated and remain within the scope of the invention. For example, the side frame 18 may have only an upper frame member 22 that may further include portions of the footrest assembly 20.

The wheelchair 10 further includes a seat support assembly, shown generally at 34. The seat support assembly 34 includes a pair of pivotally mounted cross braces 36A and 36B. The cross braces 36A and 36B are each shown mounted to the lower frame members 24 by way of lower pivot hinges 38. The lower pivot hinge 38 is illustrated as a tubular member configured to rotate about a portion of the lower frame member 24, though any pivotable hinge structure may be used. Alternatively, the lower pivot hinges 38 of the cross braces 36A and 36B may be non-pivoting structures that are removably mounted relative to the side frame 18. The cross braces 36A and 36B each connect to a seat rail 40. The seat rail 40 is illustrated in a parallel orientation to the upper frame member 22, though any relative orientation of the seat rail 40 to the side frame 18 is considered to be within the scope of the invention. Additionally, the seat rail 40 may be any frame member that is movable relative to any portion of the frame 12 of the wheelchair 10.

The frame 18 is configured to fold into a more compact size by bringing the seat rails 40 together. During folding, as the seat rails are drawn together, the cross braces pivot on the lower hinge pivots 38 about the lower frame members 24. The cross braces 36A and 36B are also pivotally pinned together at or near the linear center where the cross braces intersect. As the seat rails 40 are moved together and the braces 36A, 36B pivot relative to the lower frame member 24 and each other, the side frames 18 are drawn together, thus minimizing the width of the chair 10.

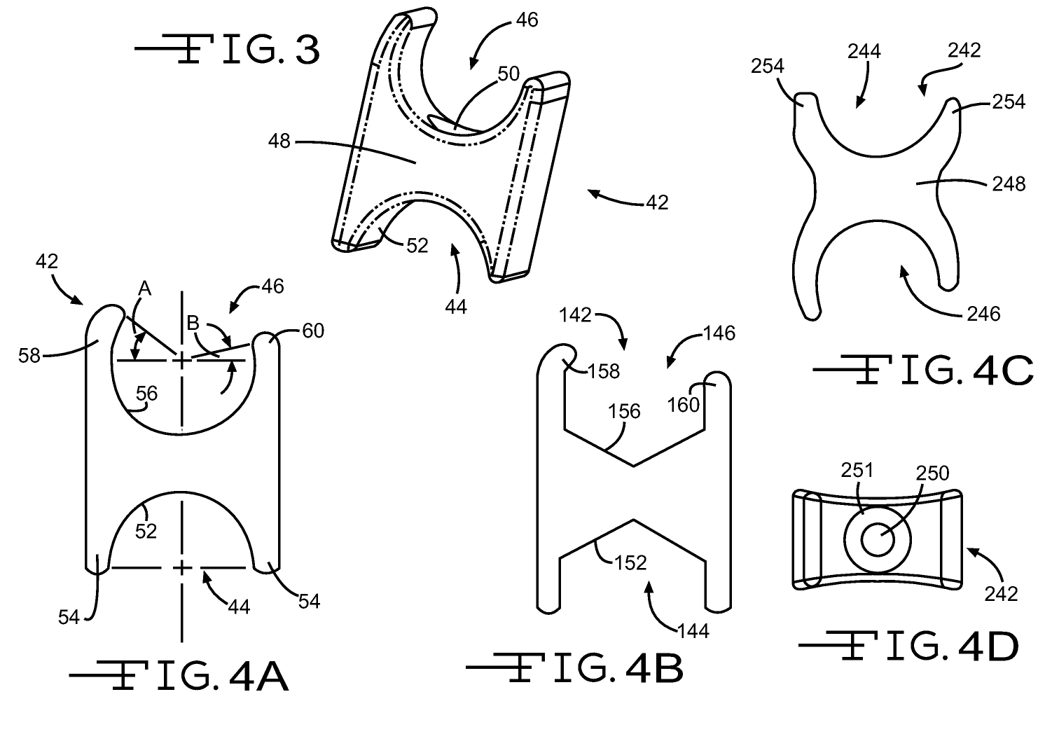

Referring now to FIGS. 2 and 3, there is illustrated a support element 42 for positioning a first frame member, such as the seat rail 40, relative to a second frame member, such as the upper frame member 22. As shown in the embodiment in FIGS. 3 and 4, the support element is illustrated as a seat rail saddle 42. The support element 42 has a frame locating feature that is a first end 44 configured to freely admit and release a frame member, such as the seat rail 40, and a frame locating feature that is a second end 46 configured to releasably retain the frame member, such as the seat rail 40. The first end 44 and the second end 46 are configured to engage frame members having generally the same geometry. Though the first and second ends 44 and 46 are shown oriented in a single plane (for example, where the engaged frame members may be generally parallel), such is not required. The first end 44 may be angularly oriented relative to the second end 46 such that the mated frame members may be crossed or otherwise not parallel. The seat rail saddle 42 includes a center body portion 48 having an aperture 50 formed therethrough. In the embodiment of a support member 242 shown in FIGS. 4C, 4D, and 5, the aperture may be an aperture 250 that includes a counterbore 251 such that a fastener 253 may pass through and be positioned completely below one of the first and second ends 244 and 246, respectively. The fastener 253 may be any structure configured to secure the saddle 242, or any embodiment thereof, to a frame member, such as the frame member 22.

Referring now to FIG. 4A, the first end 44 of the saddle 42 is illustrated as a semicircular opening having an arcuate surface 52 and extending side walls 54. The arcuate surface 52 of the first end 44 mates with the outer surface of, for example, the frame member 22 or the seat rail 40. The arcuate surface 52 is configured to extend up to, but not significantly in excess of, 180 degrees around the perimeter of the mated frame member. The extending side walls 54 are illustrated having the same height, though such is not required. The fit between the first end 44 and the mating frame member 22 (or the seat rail 40) may be a loose fit or a slight interference fit. If the saddle 42 is made from an elastic material, such as a plastic, the slight interference fit may cause the first end 44 to expand and conform to the surface of the frame 22. The first end 44 allows the mated frame member to be generally freely admitted into or released from engagement with the saddle 42, as will be explained in detail below.

The second end 46 of the saddle 42 is illustrated as a generally circular opening having an arcuate surface 56 and extending side walls 58 and 60. The arcuate surface 56 of the second end 46 mates with the outer surface of, for example, the frame member 22 or the seat rail 40. The arcuate surface 56 is configured to extend in excess of 180 degrees around the perimeter of the mated frame member. The extending side wall 58 of the second end 46 is shown extending the arcuate surface 56 beyond the centerline of the circular shape by an angle “A”. The opposite extending side wall 60 is shown extending the arcuate surface 56 beyond the centerline of the circular shape by an angle “B”. The angle A is illustrated as being larger than angle B, however, in an alternative embodiment the angles may be equal.

FIG. 4B shows an alternative embodiment of a saddle 142 having a first end 144 with a non-arcuate surface 152. The surface 152 is illustrated as a portion of a hexagon that is configured to engage a frame member having a hexagonally shaped cross section. Likewise, a second end 146 includes a hexagonally shaped surface 156. Though shown and described as generally hexagonal in shape, the first and second ends 144 and 146 may be any shape. The second end 146 includes a first extending side wall 158 and a second extending side wall 160. The extending side walls 158 and 160 conform to the geometry of the mating frame member and engage more than half of the frame member perimeter. The extending side walls 158 and 160 are shown having unequal lengths, though such is not required. The extending side wall 158 conforms around the hexagonal shape such that surface 156 prevents the mating frame member from being removed from the second end 146 without causing a deflection of one or both of the extending side walls 158 and 160. FIG. 4C shows an alternative embodiment of a saddle 242 having a center body portion 248 that is narrower than the distance across extending side walls 254. Alternatively, the center body portion 248 may be larger than the distance across the extending side walls 254.

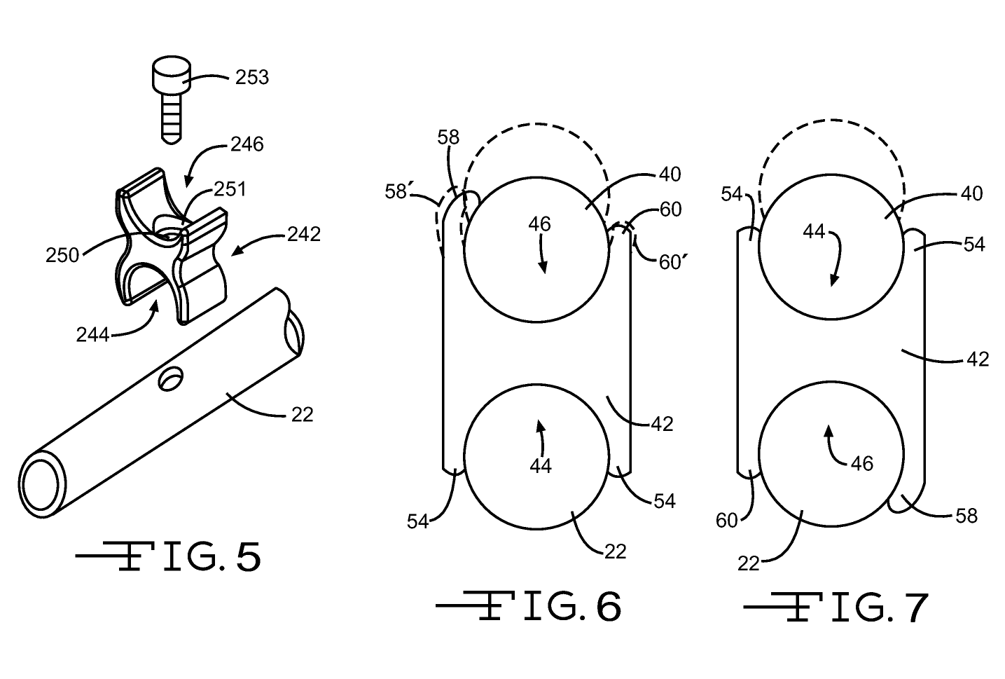

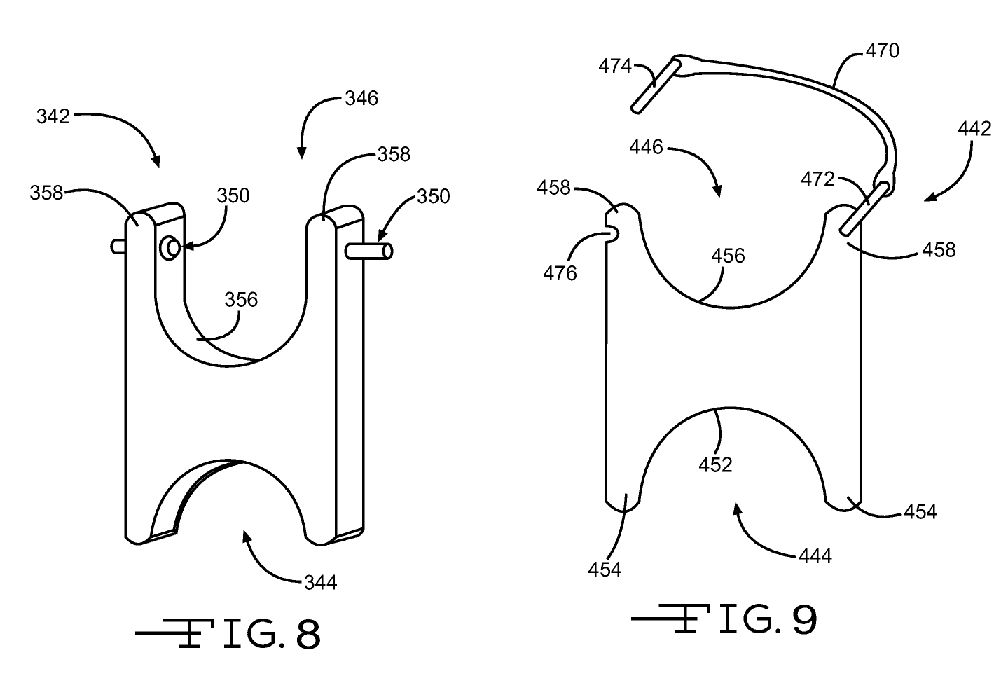

As shown in FIGS. 6 and 7, the saddle 42, and any of the embodiments described herein, engages the frame member, for example upper frame member 22 or seat rail 40, in a reversible manner with either the first end 44, 144, 244, 344, 444 or the second end 46, 146, 246, 346, 446. As shown in FIG. 6, the first end 44 engages the upper frame member 22. The first end is configured to freely admit and release the frame member 22. The saddle 42 may be secured to the frame member 22 by the fastener 253, as previously described. The seat rail 40 engages the second end 46 in a snap fit relationship. As the seat rail 40 is brought into engagement or released from engagement with the second end, one or both of the extending side walls 58 and 60 deflects outwardly. The outwardly deflected condition of the side walls 58 and 60 is shown by the dashed lines 58′ and 60′ in FIG. 6. Thus, when the saddle 42 is oriented with the second end 46 engaging the seat rail 40 (or any other moveable frame member), the seat rail 40 is retained such that a force is required to deflect at least one of the extending side walls 58 and 60. This orientation of the saddle 42 retains the seat rail 40 relative to the upper frame member 22 to provide a generally rigid ride characteristic.

Referring now to FIG. 7, the saddle 42 is shown in a reverse orientation to that of FIG. 6. The second end 46 engages the upper frame member 22 in a snap fit relationship. The saddle 42 may be secured to the frame member 22 by the fastener 253 to prevent relative movement, though such is not required. The first end 44 engages the seat rail 40 in a nested or floating condition that allows the seat rail 40 to be freely moved relative to the upper frame member 22. This orientation of the saddle 42 locates the seat rail 40 relative to the upper frame member 22 to provide a more compliant ride characteristic generally associated with conventional folding wheelchairs. In operation, if the wheelchair user wants a rigid feel, the user may secure the first end 44 to the upper frame member 22 by way of the fastener 253. The seat rail 40 may then be releasably retained by, for example, the extending side walls 58, 60 of the second end 46 engaging the perimeter of the seat rail 40. In contrast, if the user wants a looser or more compliant fit, the second end 46 may be secured to the side frame member 22 by either the fastener 253, the locking feature of the second end 46 (or any of the other locking end embodiments described herein), or both. The seat rail 40 is then freely admitted into engagement with the first end 44 such that the rail 40 nests in the “U”-shape portion of the first end 44.

Referring now to FIGS. 8 and 9, there are shown two alternative embodiments of a reversible seat rail saddle. A seat rail saddle 342 is shown in FIG. 8 having a first end 344 configured to freely admit or release the seat rail 40 as described above. The saddle 342 includes a second end 346 that is configured to releasably retain the seat rail 40 and having a frame locating surface 356, shown in FIG. 8 as a semicircular shape though any shape may be used. The second end 346 has a pair of spaced apart ball locks 350 positioned in extending side walls 358. The ball locks 350 can be conventional in the art and can be actuated to release the seat rail 40 from the second end 346 of the saddle 342. The ball locks 350 have a surface (for example, a ball bearing) that may be positioned to engage the seat rail 40 at a point beyond the widest dimension. This relative orientation prevents the seat rail 40 from being removed from the second end 346 unless the ball locks are released, and therefore is a means for releasably retaining the seat rail 22. Alternatively, the seat rail 40 may have a detent (not shown) that engages with the ball locks 350 to prevent release of the seat rail 40 from the second end 346. This arrangement may allow the extending side walls 358 to be shorter than as previously described and illustrated in FIG. 8. Additionally, the use of the ball locks 350 may eliminate the need for the fastener 253 to retain the saddle 342 and provide a more compliant frame feeling to the user when the saddle 342 is mounted, for example, as shown in FIG. 7.

Referring now to FIG. 9, another embodiment of a reversible seat rail saddle 442 is illustrated. The saddle 442 has a first end 444 configured to freely admit and release the seat rail 40, as described above, and further includes a frame locating surface 452 and extending side walls 454. The saddle 442 has a second end 446 that is configured to releasably retain the seat rail 40. The second end 446 has a pair of extending side walls 458 and a frame locating surface 456, which is shown in FIG. 9 as a semicircular shape though any shape may be used. The first end 444 and the second end 446 are configured the same with respect to the first and second end frame locating surfaces 452 and 456. The surfaces 452 and 456 are semicircular arcuate segments that extend up to, but not in excess of, 180 degrees around the perimeter of the mated frame member. The surfaces 452 and 456 may be any shape desired. The extending side walls 454 are illustrated having the same height relative to each other and to the second end extending side walls 458, though such is not required. The second end includes a locking clamp 470. The clamp 470 may be a flexible strap or a rigid cap. The clamp 470 is shown having a hinge 472 that is pivotally connected to one of the extending side walls 458. A buckle 474, which is conventional in the art, releasably secures the clamp 470 to the other extending side wall 458 by engaging a locking detent 476. The clamp 470 may have a pair of buckles, similar to buckle 474, located at each end and may be completely detachable from the saddle 442. Additionally, the use of the clamp 470 may eliminate the need for the fastener 253 to retain the saddle 442 and provide a more compliant frame feeling to the user when the saddle 442 is mounted, for example, as shown in FIG. 7.

The principle and mode of operation of this invention have been explained and illustrated in its preferred embodiment. However, it must be understood that this invention may be practiced otherwise than as specifically explained and illustrated without departing from its spirit or scope.

What is claimed is:

1. A support element for positioning a wheelchair seat rail and a frame member relative to each other, the support element having a first end configured to freely admit and release one of the seat rail and the frame member and a second end configured to releasably retain the other of the seat rail and the frame member.

2. The support element of claim 1 wherein the seat rail and the frame member are parts of a folding wheelchair frame,

3. The support element of claim 2 wherein the seat rail and the frame member have substantially the same cross sectional size and shape such that the support element is configured for reversible orientation relative to both the seat rail and the frame member.

4. The support element of claim 1 wherein the first end includes an arcuate surface and extending side walls configured to engage a perimeter portion of one of the seat rail and the frame member and the second end includes an arcuate surface and extending side walls configured to engage a perimeter portion of the other one of the seat rail and the frame member.

5. The support element of claim 4 wherein the arcuate surface of the first end is configured to extend up to 180 degrees around the perimeter of one of the seal rail and the mated frame member and the arcuate surface of the second end is configured to extend greater than 180 degrees around the perimeter of the other of the seat rail and the frame member.

6. The support element of claim 5 wherein the second end includes extending side walls having an elastic characteristic such that the one of the seat rail and frame member is retained therein by a snap fit.

7. The support element of claim 4 wherein arcuate surfaces of the first end and the second end are configured freely admit and release the seat rail and the mated frame member, the second end further including a clamp retaining device.

8. The support element of claim 4 wherein arcuate surfaces of the first end and the second end are configured to freely admit and release the seal rail and the mated frame member, the second end further including a ball lock retaining device.

9. The support element of claim 1 wherein a center body portion is disposed between the first end and the second end, the center body portion having an aperture configured for securing the support element with a fastener to one of the seat rail and the frame member.

10. A wheelchair comprising:
a frame having a first frame member;
a second frame member that is movable relative to the first frame member; and
a support element having a first end configured to freely admit and release one of the first and second frame members and a second end configured to releasably retain the other one of the first and second frame members.

11. The wheelchair of claim 10 wherein the first frame member is a side frame and the second frame member is a seat rail.

12. The wheelchair of claim 10 wherein the support element is configured to be reversibly fixed to one of the first and second frame members.

13. The wheelchair of claim 10 wherein the support element has a first end configured to engage no greater than half of a perimeter of one of the first and second frame members.

14. The wheelchair of claim 13 wherein the support member first and second ends have a generally circular frame locating feature.

15. The wheelchair of claim 13 wherein the support member first and second ends have a non-circular frame locating feature.

16. The wheelchair of claim 10 wherein the second end is configured to have a snap fit relationship with one of the first and second frame members.

17. The wheelchair of claim 16 wherein the support member is made from an elastic material such that the second end deflects to release the one of the first and second frame members.

18. The wheelchair of claim 10 wherein the second end of the support member has a ball lock retaining device.

19. The wheelchair of claim 10 wherein the second end of the support member has a clamp retaining device.

20. A folding wheelchair comprising:
a frame having spaced apart first and second side frame members;
a pair of intersecting cross braces, the first cross brace pivotally connected to the first side frame and extending to the second side frame in an unfolded position and the second cross brace pivotally connected to the second side frame and extending to the first side frame in the unfolded position;
a first seat rail connected to the first cross brace and positioned adjacent to the second side frame member in the unfolded position and a second seat rail connected to the second cross brace and positioned adjacent to the first side frame member in the unfolded position; and
a reversible seat rail saddle connecting the first seat rail to the second side frame member and having a first end configured to freely admit and release one of the first and second frame members and a second end configured to releasably retain the other one of the first and second frame members.
